(19) United States
(12) Patent Application Publication
(10) Pub. No.: US 2018/0244534 A1
(43) Pub. Date: Aug. 30, 2018

(54) CHALCOGENIDE MATERIALS, CHALCOGENIDE-BASED MATERIALS, AND METHODS OF MAKING AND USING THE SAME

(71) Applicant: Board of Regents of the Nevada System of Higher Education, on behalf of the University of Nevada,, Reno, NV (US)

(72) Inventors: Vaidyanathan Subramanian, Sparks, NV (US); Pawan Pathak, Reno, NV (US); Satyajit Gupta, Rehovot (IL)

(73) Assignee: Board of Regents of the Nevada System of Higher Education, on behalf of the University of Nevada,, Reno, NV (US)

(21) Appl. No.: 15/558,984

(22) PCT Filed: Mar. 15, 2016
(86) PCT No.: PCT/US2016/022492

§ 371 Date: Sep. 15, 2017

Related U.S. Application Data
(60) Provisional application No. 62/134,503, filed on Mar. 17, 2015.

(51) Int. Cl. C01G 11/02; C01G 21/21; C25B 1/00; C25B 11/04

(52) U.S. Cl. CPC C01G 11/02; C01G 21/21; C25B 1/003; C25B 11/0405; C01P 2006/40; C01P 2002/72; C01P 2004/04; C01P 2002/84; C01P 2004/03; C25B 11/0447

(57) ABSTRACT

Disclosed herein are embodiments of chalcogenide materials and chalcogenide-based materials that exhibit improved light-driven properties and performance in comparison to conventional materials. Also disclosed herein are embodiments of cost- and time-efficient methods of making such materials.

### CROSS REFERENCE TO RELATED APPLICATION

This application claims the benefit of, and priority to, the earlier filing date of U.S. Provisional Application No. 62/134,503, filed on Mar. 17, 2015, which is incorporated herein by reference in its entirety.

### ACKNOWLEDGMENT OF GOVERNMENT SUPPORT

This invention was made with government support under contract number NSF-CBET 1337050 awarded by the National Science Foundation (NSF). The government has certain rights in the claimed invention.

### FIELD

The present disclosure concerns embodiments of chalcogenide-based materials, and methods for making and using the same.

### BACKGROUND

Hetero-structured optoelectronic materials (HOMs) are complex structures that consist of a unique combination of high surface area substrates and a visible light harvester, such as a chalcogenide. The intimate coupling of low bandgap chalcogenide nanocrystals with a wide bandgap oxide surface to enhance a broad band solar-spectrum absorbance, facile charge separation/transportation, and boost efficiency is a challenging task. All the approaches to assemble such HOMs that are known today involve multiple steps, require reagents that do not contribute to HOM activity (e.g., surfactants), and/or have building components that can prevent the formation of intimate electronic contact between the large and small bandgap oxide leading to reduced performance of the HOM (e.g., organic functional groups). Methods for simplifying the integration of chalcogenides onto substrates using minimal extraneous additives that do not participating in light-matter interactions are needed in the art for assembling these materials for various applications.

### SUMMARY

Disclosed herein are embodiments of a chalcogenide material having a formula MXₙ, wherein

M is selected from Cd, Cu, Pb, or Zn;

X is a chalcogen selected from S, Se, Te, or combinations thereof;

n is 1 or 2; and

wherein the chalcogenide material exhibits high crystallinity and is chalcogen-deficient. In some embodiments, M is Cd or Pb, X is S, and n is 1. In some embodiments, the chalcogenide material is chalcogen-deficient such that it comprises from greater than zero atomic % of the chalcogen to less than 1 atomic % of the chalcogen. In some embodiments, the chalcogenide material is chalcogen-deficient such that it comprises from 0.1 atomic % of the chalcogen to less than 0.95 atomic % of the chalcogen. The chalcogenide material has a high crystallinity of the chalcogenide material, wherein high crystallinity comprises a high intensity ratio ranging from 2 to 5. In some embodiments, the high crystallinity of the chalcogenide material comprises a high intensity ratio of 3 to 4. In particular disclosed embodiments, the chalcogenide material is CdS or PbS, and the CdS or PbS exhibits high crystallinity comprising an intensity ratio of 3 to 4 and comprises greater than zero atomic % sulfide to less than 1 atomic % sulfide. In exemplary embodiments, the chalcogenide material is CdS and the CdS exhibits high crystallinity of 3.90 to 4.0 (such as 3.96) and comprises 0.81 to 0.85 atomic % sulfide. In some embodiments, the chalcogenide material produces a photocurrent ranging from 1.5 mA cm⁻² to 9 mA cm⁻².

Also disclosed herein are embodiments of a composition for producing a chalcogenide material or a chalcogenide-based material, comprising a chalcogenide precursor having a formula ML₁L₂ wherein M is selected from Cd, Cu, Pb, or Zn and each of L₁ and L₂ independently is selected from a ligand comprising at least one chalcogen. In such embodiments, the chalcogenide material or chalcogenide-based material exhibits high crystallinity and is chalcogen-deficient. In some embodiments, the composition further comprises a solvent. In some embodiments, the solvent is oleylamine. In particular embodiments, M is Cd or Pb. In some embodiments, each of L₁ and L₂ independently is selected from a dithiocarbamate, a dithiol, or a xanthate. The compositions can produce chalcogenide materials or chalcogenide-based materials having any of the properties mentioned above for the chalcogenide materials (and any combinations thereof).

Also disclosed herein are embodiments of a combination, comprising the chalcogenide materials described herein and a substrate. Additionally, methods of making a chalcogenide-coated substrate are disclosed. Some method embodiments comprise exposing a substrate to a composition comprising a chalcogenide precursor having a formula ML₁L₂ wherein M is selected from Cd, Cu, Pb, or Zn and each of L₁ and L₂ independently is selected from a ligand comprising at least one chalcogen; and wherein the chalcogenide-coated substrate produces a photocurrent ranging from 1.5 mA cm⁻² to 9 mA cm⁻². In some embodiments, exposing the substrate to the composition comprises dipping the substrate into the composition at a temperature and for a time period sufficient to deposit a chalcogenide material onto the substrate. The temperature can range from 140° C. to 240° C. and the time period can range from 45 minutes to 60 minutes. In some embodiments, the chalcogenide-coated substrate is substantially coated with the chalcogenide material. In particular disclosed embodiments, the method consists of exposing the substrate to the chalcogenide precursor at a temperature and for a time sufficient to deposit a chalcogenide material onto the substrate.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 is a combined x-ray diffraction (XRD) spectrum illustrating XRD spectra obtained from a representative bare substrate and a representative chalcogenide-based material.

FIG. 2 is an XRD spectrum of CdS made using a conventional technique.

FIG. 3 is an XRD spectrum of CdS made using a conventional technique.

FIG. 4 is an image showing a high resolution FFT pattern, which provides d-spacing values, wherein 0.33 nm corresponds to the 002 plane, 0.203 nm corresponds to the 110 plane, and 0.175 nm corresponds to the 112 plane.

FIG. 5 is a schematic diagram illustrating an exemplary embodiment of a method of making representative chalcogenide-based materials disclosed herein.

FIG. 6 is an image showing various substrates coupled to representative chalcogenide materials made using various chalcogenide precursor concentrations.

FIG. 7 is a schematic diagram illustrating a representative fabrication method to produce rainbow architectures of chalcogenide materials.

FIG. 8 illustrates an exemplary photoelectrochemical device comprising a chalcogenide-based material.

FIG. 9 is an SEM image of a bare substrate, wherein the inset illustrates a cross sectional view of the smooth substrate surface.

FIG. 10 is an SEM image of a substrate with a deposited chalcogenide, wherein the inset provides a cross-sectional view of the coated substrate-chalcogenide interface.

FIG. 11 is an SEM image of a cross-sectional surface of a bare substrate.

FIG. 12 is an SEM image of a cross-sectional surface of a substrate with a deposited chalcogenide material.

FIG. 13 is an SEM image of a substrate with a deposited chalcogenide material made using a chalcogenide precursor at 0.1 mM.

FIG. 14 is an SEM image of a substrate with a deposited chalcogenide material made using a chalcogenide precursor at 1 mM.

FIG. 15 is an SEM image of a substrate with a deposited chalcogenide material made using a chalcogenide precursor at 3 mM.

FIG. 16 is a TEM image of a substrate with a deposited chalcogenide material.

FIG. 17 is a TEM image of a representative chalcogenide-based material.

FIG. 18 is TEM images of a representative chalcogenide-based material.

FIG. 19 is a TEM image of the representative chalcogenide-based material of FIG. 18 at high magnification.

FIGS. 20A-20C are images of color coded images of a representative chalcogenide-based material; FIG. 20A illustrates a color coded image illustrating a Cd component of the chalcogenide-based material; FIG. 20B is a color coded image illustrating a sulfur component of the chalcogenide-based material; and FIG. 20C is a color coded image illustrating a Ti component of the chalcogenide-based material.

FIG. 21 is an image illustrating results obtained from energy-dispersive x-ray spectroscopy (EDAX) analysis of the material illustrated in FIGS. 20A-20C.

FIG. 22 is a graph of absorbance (a.u.) as a function of wavelength (nm) illustrating the UV-visible absorbance spectra of exemplary chalcogenide-based materials obtained using various chalcogenide precursor concentrations.

FIG. 23 is a graph of photocurrent density (mA cm⁻²) as a function of time (seconds) illustrating results obtained from electrochemical analysis of a representative chalcogenide-based material obtained using various concentrations of a chalcogenide precursor.

FIG. 24 is a graph of photocurrent density (mA cm⁻²) as a function of time (seconds) illustrating results obtained from electrochemical analysis of a representative chalcogenide-based material obtained using 2 mM of a chalcogenide precursor.

FIG. 25 is a graph of photocurrent density (mA cm⁻²) as a function of time (seconds) illustrating results obtained from electrochemical analysis of a representative chalcogenide-based material obtained using 2 mM of a chalcogenide precursor.

FIG. 26 is a graph of photocurrent density (mA cm⁻²) as a function of voltage illustrating results obtained from electrochemical analysis of a representative chalcogenide-based material obtained using various concentrations of a chalcogenide precursor.

FIG. 27 is a graph of photocurrent density (mA cm⁻²) as a function of voltage illustrating results obtained from electrochemical analysis of a representative chalcogenide-based material obtained using 2 mM of a chalcogenide precursor.

FIG. 28 is a graph of photocurrent density (mA cm⁻²) as a function of time (seconds) illustrating results obtained from long-term stability analysis of a representative chalcogenide-based material obtained using an exemplary method disclosed herein.

FIG. 29 is a graph of photocurrent density (mA cm⁻²) as a function of time (seconds) illustrating results obtained from long-term stability analysis of a chalcogenide-base material obtained using a SILAR method; the current value continues to decrease after 1 hour, whereas the current produced by the embodiment of FIG. 28 remains stable after 1 hour.

FIG. 30 is a graph of photocurrent density (mA cm⁻²) as a function of time (seconds) illustrating that chalcogenide-based materials disclosed herein exhibit 145% improved photocurrent density as compared to a conventional SILAR technique due at least in part to the superior contact between the chalcogenide and the substrate.

FIG. 31 illustrates a schematic and graphical illustration of a rainbow architecture using a representative chalcogenide-based material.

FIG. 32 is a combined spectrum showing photoluminance (PL) spectra illustrating that materials obtained from the chalcogenide-based method embodiments disclosed herein have less radiative recombination of electron hole pair as compared to materials obtained using conventional SILAR methods.

FIG. 33 is a Nyquist plot illustrating that materials made using the chalcogenide-based method embodiments disclosed herein have less charge transfer resistance as compared to materials made using conventional SILAR methods.

FIG. 34 is a Bode phase plot illustrating that materials made using the chalcogenide-based method embodiments disclosed herein have higher average life time of the electron as compared to materials made using conventional SILAR methods.

FIG. 35 is a graph of photocurrent (mA cm⁻²) as a function of time (seconds) for a PbS chalcogenide crystal.

FIG. 36 is a graph of photocurrent (mA cm⁻²) as a function of voltage for a PbS chalcogenide crystal made using different lead sulfide precursor concentrations.

FIG. 37 is a graph of absorbance (a.u.) as a function of wavelength (nm) illustrating the UV-visible absorbance spectra of at PbS chalcogenide crystal in titanium nanotubes using various chalcogenide precursor concentrations.

FIG. 38 is an image showing various substrates coupled to representative PbS chalcogenide materials made using various chalcogenide precursor concentrations.

### DETAILED DESCRIPTION

### I. Explanation of Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

The present disclosure is directed toward all novel and non-obvious features and aspects of the various disclosed embodiments, alone and in various combinations and sub-combinations with one another. The disclosed devices, materials, and methods are not limited to any specific aspect or feature or combinations thereof, nor do the disclosed devices, materials, and methods require that any one or more specific advantages be present or problems be solved. Any theories of operation are to facilitate explanation, but the disclosed devices, materials, and methods are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed devices, materials, and methods can be used in conjunction with other devices, materials, and methods. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or devices are referred to as “lowest,” “best,” “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

To facilitate review of the various embodiments of the disclosure, the following explanations of specific terms are provided:

Chalcogenide: A chemical compound comprising at least one chalcogen component and at least one electropositive component. In some embodiments, a chalcogenide can comprise a sulfide, a selenide, a telluride, or a combination thereof. A chalcogenide-based material, as described herein, comprises a chalcogenide material that is coupled to a substrate as described herein.

Chalcogen: A chalcogen is an element belonging to Group 16 of the Periodic table. In some embodiments, a chalcogen is selected from sulfur (or sulfide, S⁻²), selenium (or selenide, Se⁻²), tellurium (or telluride, Te⁻²), or a combination thereof.

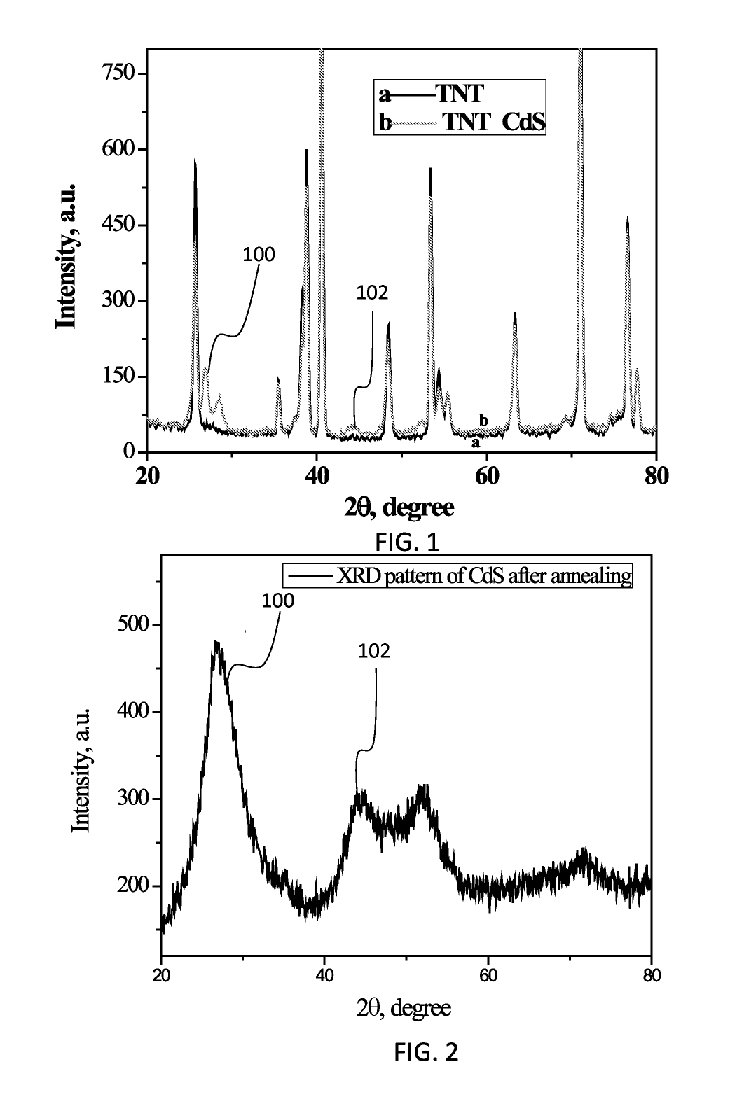

Crystallinity: The crystallinity of the disclosed chalcogenide materials can be determined using an x-ray diffraction (XRD) technique and/or visual evaluation. In some embodiments using XRD to determine the crystallinity of the disclosed chalcogenide materials, the crystallinity can be quantified as an intensity ratio, which is measured by comparing the signature peaks obtained from XRD analysis of a chalcogenide material (or a chalcogenide-based material). Solely by way of example, a CdS material made according to the methods described herein can produce two signature peaks (e.g., peaks 100 and 102 as illustrated in FIG. 1) which can be used to calculate the intensity ratio and thereby provide quantification of the crystallinity of the material. In some embodiments, the peaks used to calculate the intensity ratio can be identified using a suitable database to identify signature peaks of the chalcogenide material (or chalcogenide-based material) being analyzed. The intensity value (e.g., measured as atomic units, or a.u.) of the most intense signature peak can then be divided by of the intensity value of the other, less-intense signature peak to provide the intensity ratio.

Chalcogen-rich: This term refers to a chalcogenide material or chalcogenide-based material that comprises a chalcogen component having an atomic percent ranging from greater than or equal to 1 atomic % to 3 atomic %, such as 1 atomic % to 3 atomic %, or 1.2 atomic % to 2.5 atomic %, or 1.4 atomic % to 2 atomic %.

Chalcogen-deficient: This term refers to a chalcogenide material or chalcogenide-based material that comprises a chalcogen component having an atomic percent ranging from greater than zero to less than 1 atomic %, such as 0.1 atomic % to 0.95 atomic %, or 0.5 atomic % to 0.9 atomic %, or 0.75 atomic % to 0.85 atomic %.

### II. Introduction

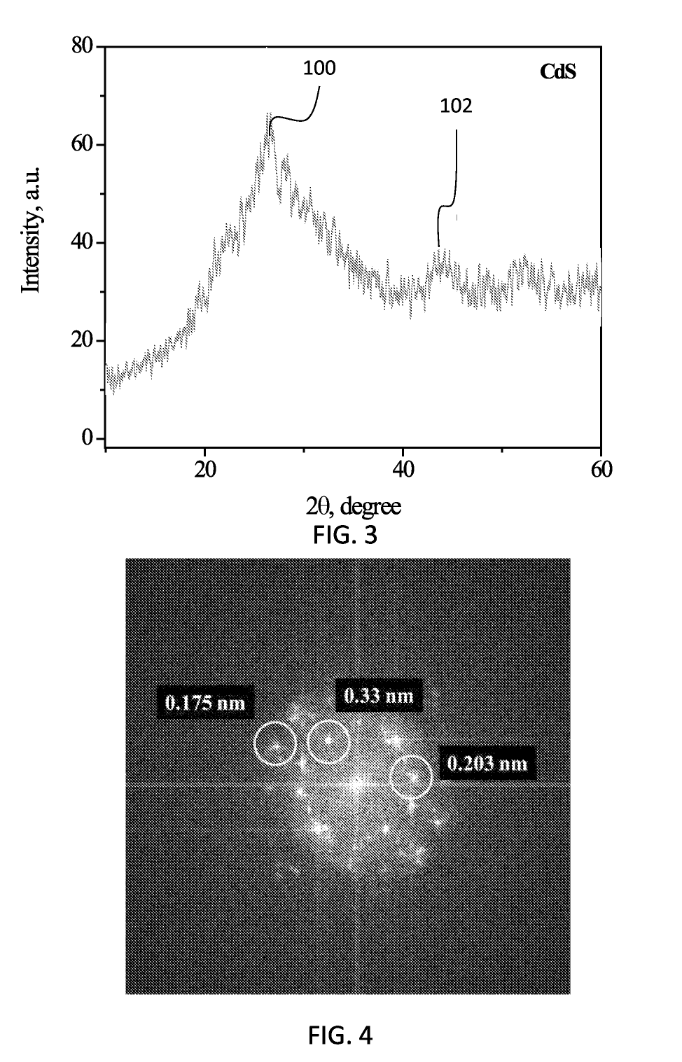

Quantum dot (QD) materials (e.g., chalcogenide quantum dots) display unique optical, electronic, catalytic, size, and shape dependent properties which make them a useful component in hetero-structured optoelectronic materials (or “HOM”). Conventional methods for chalcogenide synthesis exist; however, these conventional methods have a variety of drawbacks that limit their utility and applicability. For example, reverse micelle methods used in the field require using surfactant-stabilized micro emulsions, which must be removed after the synthesis of the chalcogenide. In some conventional techniques, bi-functional linker-“mercaptans”-assisted synthesis can be used; however, these methods (and products or side products produced with such methods) can interfere with charge transport, require time-consuming process times (often longer than 24 hours reaction time), and further exhibit low photocurrents (e.g., 2.0 mA cm⁻² or lower). Alternatively, chalcogenide deposits on high surface area oxide films have been prepared using a “successive ionic layer adsorption and reaction” approach (referred to as SILAR). SILAR synthesis methods require several cycles of a layer by layer assembly approach, which requires long synthesis times to obtain a material capable of providing a desirable photocurrent value. Additionally, expensive programmable dip-coater technology is required to provide controlled deposition utilizing this method. Additionally, electrochemical methods require external electric fields and limit the extent of deposit formation on highly intricate surfaces. Solvothermal approaches used to grow coatings of chalcogenides have been used, but such methods require high pressure and long reaction times to achieve desired results. Additionally, such methods require complex, two-component precursors and further requires multiple surface treatments. Chemical vapor deposition methods also include drawbacks that work against their utility, such as the need to utilize vacuum chambers and sophisticated tools; such methods are expensive and therefore are less desirable for industrial application. FIGS. 2 and 3 show results obtained from XRD analysis of CdS made using conventional techniques.

In contrast to the conventional techniques disclosed above, the methods disclosed herein provide a simplified, user friendly approach for making chalcogenide materials (and chalcogenide-based materials) exhibiting improved photoactivity, crystallinity, and substrate-coupling. The methods disclosed herein do not require long reaction times; some embodiments can be used to make chalcogenide materials (and chalcogenide-based materials) in under 60 minutes. The methods disclosed herein also utilize a facile dip casting method to provide chalcogenide-based materials having uniform deposition of chalcogenide materials, which exhibit superior coupling/contact with the substrate or material to which it is coupled. Additionally, the methods disclosed herein are cost-efficient and readily reproducible and scalable.

### III. Materials

The chalcogenide materials and chalcogenide-based materials disclosed herein are useful for energy conversion, biomedical applications, sensing, and catalysis. The chalcogenide materials and chalcogenide-based materials can comprise a chalcogen component and an electropositive component. In some embodiments, the chalcogenide material can have a formula M(X)ₙ, wherein M is a metal selected from Group 11, 12, or 14 of the periodic table; X is selected from a chalcogen belonging to Group 16 of the periodic table; and n can be 1 or 2. Suitable chalcogen components can be selected from sulfur, selenium, tellurium, or combinations thereof. In some exemplary embodiments, sulfur was used as the chalcogen component. In some embodiments, the electropositive component can be a metal selected from copper, cadmium, lead, zinc, or a combination thereof. In exemplary embodiments, cadmium and lead were used as the electropositive component. Exemplary chalcogenide materials include, but are not limited to, CdS, PbS, ZnS, CuS, CdSe, PbSe, ZnSe, CuSe, CdTe, PbTe, ZnTe, CuTe, and the like.

The chalcogenide-based materials can comprise a substrate to which the chalcogenide materials are coupled. In some embodiments, the substrate can comprise a metal oxide comprising a transition metal oxide. Such metal oxides can be selected from, but are not limited to, TiO₂, SnO₂, ZrO₂, ZnO, NiO, BaTiO₂, ZnTiO₃, CuTiO₃Fe₂O₃, CoOₓ, V₂O₅, CuO, Ta₂O₅, and Ta_{z}OₓN_{y} (wherein z can be 0 to 5 and each of x and y independently can be 0 to 6, such as 0.01 to 6, or 1 to 6, or 1 to 5). In yet additional embodiments, the substrate can further comprise a polymer, such as a poly-ethylene terephthalate (PET), polycarbonate, or combinations thereof, or a dopant, such as fluorine, nitrogen, carbon, or a combination thereof. In embodiments further comprising a polymer, the polymer can serve as a base material to which the metal oxide is coupled to thereby form a flexible substrate. The substrates can have any shape, such as tubes, rods, particles, or films. The substrates also can be any size, with some embodiments being nano-sized (e.g., nanotubes, nanorods, nanoparticles). In exemplary embodiments, the substrate comprises TiO₂, such as TiO₂ nanostructures (e.g., TiO₂ nanotubes) or TiO₂-coated glass, or fluorine-doped TiO₂.

In particular disclosed embodiments, chalcogenide materials and chalcogenide-based materials disclosed herein can be made using a chalcogenide precursor from which the desired chalcogenide material and chalcogenide-based material can be obtained. In particular disclosed embodiments, the chalcogenide precursor can have a formula ML₁L₂, wherein M is an electropositive metal selected from those described herein; and each of L₁ and L₂ independently can be selected from a component (e.g., a functional group) comprising at least one chalcogen. In some embodiments, each of L₁ and L₂ can be selected from a thiocarbamate, a dithiol (e.g., alkyl dithiols, benzene dithiol, tetra(ethylene glycol) dithiol, 5,5′-bis(mercaptomethyl)-2,2′-bipyridine), or a xanthate (e.g., sodium ethyl xanthate, potassium ethyl xanthate, sodium isopropyl xanthate, sodium isobutyl xanthate, potassium amyl xanthate). In an exemplary embodiment, the chalcogenide precursor was Cd dithiocarbamate (or Cd[(C₂H₅)₂NCS₂]₂). The chalcogenide precursors can be prepared from suitable starting materials, which are recognized by those of ordinary skill in the art.

The chalcogenide precursors can be readily degraded to provide the desired chalcogenide. In some embodiments, the chalcogenide precursor is heated at a temperature and for a time sufficient to degrade to the desired chalcogenide. In particular disclosed embodiments, the temperature can be a temperature ranging from 140° C. to 250° C., such as 150° C. to 220° C., or 160° C. to 180° C. In some embodiments, the temperature range used can be selected based on the particular chalcogenide precursor being used. The chalcogenide precursors also can be degraded in a short time period to provide the desired chalcogenide. In some embodiments, the time needed to produce the chalcogenide-based materials can be 300% to 3100% faster than times used in conventional methods described herein, such as 1000% to 3000% faster, or 2000% to 2500% faster. In particular disclosed embodiments, the time needed to produce the chalcogenide (or chalcogenide-based material) can range from 30 minutes to 180 minutes, such as 100 minutes to 140 minutes, or 45 minutes to 60 minutes.

The chalcogenide materials and chalcogenide-based materials disclosed herein exhibit higher crystallinity compared to chalcogenides produced using conventional techniques. In some embodiments, the chalcogenide materials and chalcogenide-based materials can be nanocrystals having higher crystallinity than that of chalcogenides prepared using conventional methods described above. In some embodiments, the chalcogenide materials and chalcogenide-based materials can have a high crystallinity value that is expressed as an intensity ratio. The intensity ratio in some embodiments can be 2-fold to 4-fold higher than intensity ratios obtained from materials made using conventional methods. In some embodiments, at least a 2-fold higher intensity ratio was obtained for exemplary chalcogenide materials and chalcogenide-based materials disclosed herein as compared to materials made using SILAR methods or CBD methods, thus exhibiting the superior crystallinity of the disclosed chalcogenide materials and chalcogenide-based materials. Solely by way of example, in an exemplary embodiment, a CdS-containing material provided an intensity ratio of 3.69, which was higher than the intensity ratios obtained for CdS materials made using conventional synthesis techniques (e.g., 1.57 for SILAR method and 1.72 for a chemical bath deposition). In some embodiments, the intensity ratio ranges from about 3.90 to about 4.0. In exemplary embodiments, the intensity ratio of the chalcogenide material or chalcogenide-based material (which, solely by way of example, can be evaluated as the peak ratio of (100) with respect to (102) as illustrated in FIG. 1), can range from 2 to 5, such as 2.5 to 4.5, or 3 to 4.

As evidenced by FIGS. 1-3, the chalcogenide materials and chalcogenide-based materials of the present disclosure exhibit increased crystallinity as compared to materials made using conventional techniques—the increased crystallinity evidenced by the high intensity ratio obtained for the two reference peaks illustrated in FIGS. 1-3 (peaks 100 and 102, with the ratio being peak 100:peak 102). Additionally, visual detection can be used to confirm the increased crystallinity of the disclosed chalcogenide-based materials. For example, FIG. 4 shows a diffraction pattern of a CdS-containing material having high crystallinity as evidenced by the bright spots illustrated in the diffraction pattern.

Another feature of the disclosed chalcogenide materials and chalcogenide-based materials that is obtained using the methods disclosed herein is the ability to obtain chalcogen-deficient materials. For example, in some embodiments, a chalcogenide material or chalcogenide-based material can comprise a chalcogen component having an atomic percent ranging from greater than zero to less than 1 atomic %, such as 0.1 atomic % to 0.95 atomic %, or 0.5 atomic % to 0.9 atomic %, or 0.75 atomic % to 0.85 atomic %. Such materials are distinct from chalcogen-rich materials obtained using conventional methods, such as SILAR and CBD methods. In an exemplary embodiment, a sulfur-deficient chalcogenide material was obtained using an embodiment of the methods disclosed herein having a sulfur content of 0.81 atomic % to 0.85 atomic %. Conventional methods used to make sulfur-containing materials typically provide sulfur-rich materials having sulfur ratios of, for example, 1 atomic %, 1.02 atomic %, 1.17 atomic %, 1.21 atomic %, or 1.39 atomic %. In particular disclosed embodiments, the atomic percent of the chalcogenide materials or chalcogenide-based materials can be determined using x-ray photoelectron spectroscopy (“XPS”) or energy-dispersive x-ray spectroscopy (“EDAX”).

The disclosed chalcogenide materials and chalcogenide-based materials also exhibit high photocurrents. In some embodiments, the photocurrents exceeded those obtained from materials synthesized using conventional methods, such as SILAR, CBD, CVD, spray deposition, and spin deposition. In some embodiments, the chalcogenide materials and chalcogenide-based materials disclosed herein produce a photocurrent ranging from 1 mA cm⁻² to 12 mA cm⁻², such as 1 mA cm⁻² to 9 mA cm⁻², or 3 mA cm⁻² to 6.5 mA cm⁻², or 6 mA cm⁻² to 10 mA cm⁻², or 6 mA cm⁻² to 10 mA cm⁻². In exemplary embodiments, photocurrents of 6 mA cm⁻², 8.2 mA cm⁻², and 9.3 mA cm⁻² were obtained using an embodiment of a chalcogenide-based material.

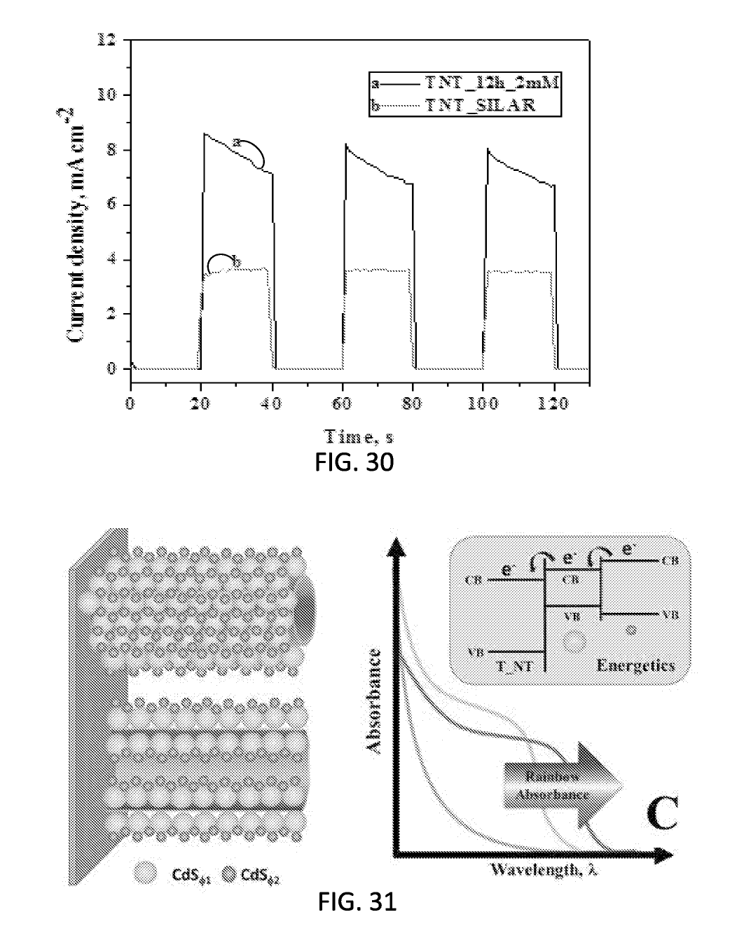

The disclosed chalcogenide materials and chalcogenide-based materials also exhibit superior contact with the substrate material to which they are coupled. Without being limited to a single theory of operation, it is currently believed that the improved contact between the chalcogenides and the substrate obtained by using the methods described herein contributes to the increased photocurrents obtained from these materials. In particular disclosed embodiments, the increased contact between the oxide of the substrate and the chalcogenide material can result from simultaneously forming the chalcogenide material in situ from the chalcogenide precursor. Other methods do not utilize this simultaneous formation and therefore do not provide the same enhanced contact exhibited by the presently disclosed chalcogenide-based materials. In an exemplary embodiment, the disclosed methods provided a superior performing chalcogenide-based material having improved contact with the substrate as illustrated by a photocurrent of 9 mA cm⁻² as compared to SILAR method (3.5 mA cm⁻²) (see, for example, FIG. 30). In some embodiments, an improved contact can be obtained to provide a 145% to 160% improved photocurrent density, with particular embodiments exhibiting a 145% and a 157% improvement.

### IV. Methods of Making the Materials

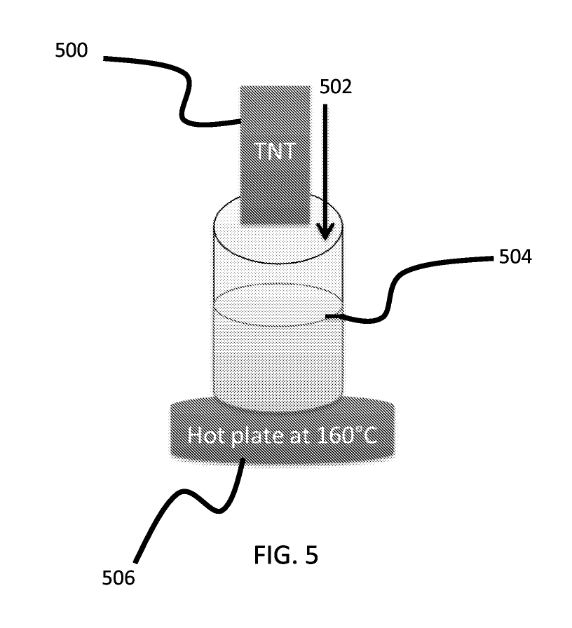

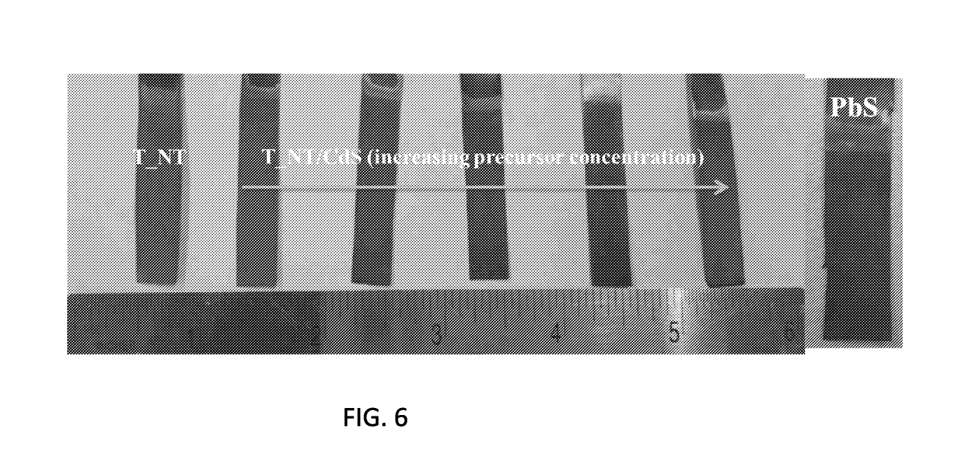

Disclosed herein are embodiments of methods for making the chalcogenide-based materials discussed above. In some embodiments, the methods can be performed under atmospheric pressure using a hot solution dip-casting technique to couple CdS nanocrystals with a titania (TiO₂) surface in-situ. In particular disclosed embodiments, the methods utilize just one step to provide the chalcogenide-based materials and do not require multiple repetitions of layering and/or dipping. An exemplary schematic illustrating an embodiment of the methods described herein is provided by FIG. 5 and the images of the exemplary chalcogenide materials and chalcogenide-based materials prepared such an exemplary embodiment are shown in FIG. 6. As illustrated in FIG. 5, embodiments of the disclosed methods can comprise coating a substrate 500 (e.g., by dipping, as illustrated by arrow 502) with a solution of a chalcogenide precursor 504. By heating solution 504, in situ deposition of the chalcogenide material can occur onto the substrate 500. Heating can be carried out using a suitable heating element or by controlling the heat of the solution using other methods known to those of ordinary skill in the art. As illustrated in FIG. 5, a heat source, such as heat plate 506 can be used.

Embodiments of the disclosed method provide uniform coverage of the CdS nanocrystals over the TiO₂ nanotube surface with a high photocurrent density. In some embodiments, the method comprises exposing a substrate to a solution comprising a chalcogenide precursor. The solution also can further comprise a solvent capable of dissolving the chalcogenide precursor. In some embodiments, the method comprises exposing the substrate to a solution consisting of a chalcogenide precursor and a solvent. Suitable solvents can be selected from, but are not limited to, alkyl amines, alkene-containing amines (e.g., oleylamine), or the like.

The substrate can be exposed to the solution comprising or consisting of the chalcogenide precursor and solvent for a time and at a temperature sufficient to promote formation of the chalogenide material on the substrate. In some embodiments, a temperature ranging from 140° C. to 240° C., such as 150° C. to 230° C., or 160° C. to 220° C. can be used to form the chalcogenide material (or chalcogenide-based material). In exemplary embodiments, a temperature of 160° C. was used. The substrate may be exposed to the solution of the chalcogenide precursor for a time ranging from 30 minutes to 180 minutes, such as 100 minutes to 140 minutes, or 45 minutes to 60 minutes. In exemplary embodiments, the chalcogenide material or chalcogenide-based material can be made in under 60 minutes, such as in 45 minutes.

Embodiments of the disclosed methods can comprise utilizing a one-pot approach to deposit a chalcogenide on a suitable substrate with no extraneous additives to provide high magnitudes of photocurrents, with some embodiments providing photocurrents superior to those obtained with conventional techniques. In some embodiments, improved stability of the photoresponse can be obtained as compared with composites formed using other conventional techniques. In some embodiments, improved stability can involve a 5% to 20% improved photocurrent after 1 hour of continuous illumination, such as 5% to 15%, or 10% to 15%, or 10% to 12% improved photocurrent stability after 1 hour of continuous illumination. In particular disclosed embodiments, chalcogenide material deposition is achieved on the surface of the substrate. The chalcogenide material can be deposited using the methods described herein so as to form a film or coating that covers the entire substrate or at least a portion of the substrate (e.g., from 50% of the substrate surface area to 99% of the substrate surface area, or 60% of the substrate surface area to 90% of the substrate surface area, or 70% of the substrate surface area to 85% of the substrate surface area). In some embodiments, the film or coating of the chalcogenide material can have a thickness ranging from 10 nm to 60 nm, such as 30 nm to 50 nm, or 25 nm to 35 nm. In some embodiments, the thickness of the film or coating of the chalcogenide material can be determined using, for example, scanning electron microscopy (SEM) analysis, optical profilmetry and elipsometry analysis, or a combination thereof.

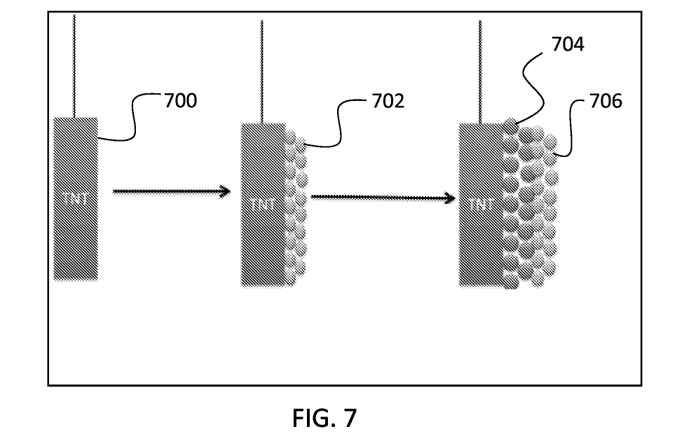

In particular disclosed embodiments, the methods can comprise utilizing the chalcogenide precursor to nucleate, deposit, and grow a chalcogenide material (or a mixture of chalcogenide materials) on a substrate to provide a broad spectrum absorbance system useful in a variety of applications, such as those described below. An exemplary schematic illustrating such a method is illustrated in FIG. 7. As illustrated in FIG. 7, a substrate 700 can be exposed to a first chalcogenide precursor solution to deposit a chalcogenide material 702 onto the substrate. As additional growth takes place and/or additional deposition steps are used, the first layer of chalcogenide material can grow in size to form larger deposits of chalcogenide material 704 as subsequent layers 706 are deposited. Another exemplary embodiment of a rainbow architecture is illustrated in FIG. 31.

### V. Methods of Using the Device

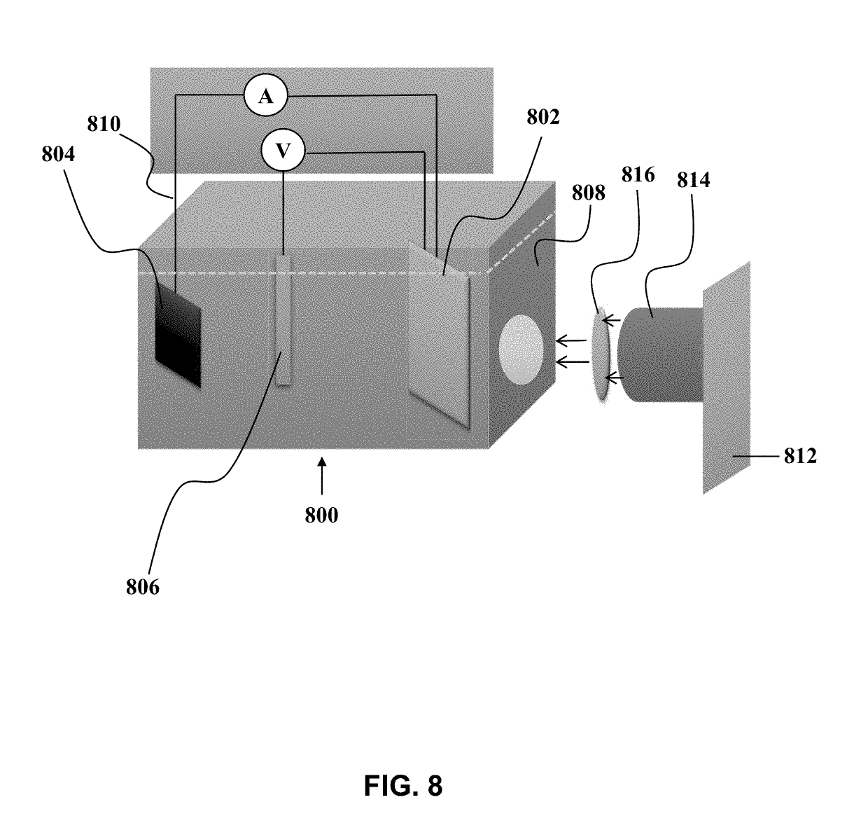

Disclosed herein are embodiments of hetero-structured optoelectronic materials that exhibit utility in myriad applications, such as, but not limited to, solar energy conversion applications, sensing components, pollution remediation, fuel production, and dielectrics. In some embodiments, the methods disclosed herein can be used in composite electrode development and therefore impact a variety of applications, such as photoelectrochemistry, PV, solar-fuels and other allied areas of energy storage and sensing. For example, the chalcogenide materials and chalcogenide-based materials can be used to form anode components that can be used in combination with a cathode (and optional reference electrode and/or separator material) to provide a fuel cell, such as a photoelectrochemical cell or a photofuel cell. Thus, the disclosed chalcogenide materials are useful in producing electricity or fuels (e.g., hydrogen) from suitable materials, such as water or organic compounds. An exemplary photoelectrochemical cell set up is illustrated in FIG. 8. As illustrated in FIG. 8, an exemplary photoelectrochemical cell 800 can include a photoanode 802 comprising a chalcogenide material as disclosed herein, a counter electrode 804 (e.g., a platinum substrate) and an optional reference electrode 806 (e.g., a Ag/AgCl reference electrode) that are contained in housing 808. Photoelectrochemical cell 800 also can comprise suitable electrical connections 810 that electrically connect the counter electrode 804 to the photoanode 802, and optionally the photoanode to the optional reference electrode 806. Photoelectrochemical cell 800 can be used in combination with an energy source 812, which can comprise a filter 814 and a lamp 816. Other types of energy sources may be used so long as they are capable of producing energy having wavelengths ranging from 370 nm to 550 nm.

In some embodiments, the chalcogenide material or chalcogenide-based material can be used alone as a device (e.g., a substrate with a layer or coating of the chalcogenide material) for pollutant remediation. Such devices also can be used in sensing applications, such as to determine the presence of, or detect, biological molecules, toxic molecules, or combinations thereof.

### VI. Examples

Sodium diethyldithiocarbamate [(C₂H₅)₂NCS₂Na), ammonium fluoride (NH₄F) and cadmium sulfate (CdSO₄) were obtained from Sigma Aldrich. Olelyamine was obtained from Across Organics. Titanium foil (Purity: 99.7%) was purchased from Strem Chemicals Inc. Dichloromethane, ethylene glycol and ethanol were obtained from local suppliers. Deionized (D.I.) water was obtained from a Millipore® lab water purification system.

### Example 1

Titanium foil was used to prepare the titanium nanotubes (T_NT). Briefly, the titanium substrate was polished and ultrasonicated with DI water, isopropanol, and acetone separately for 5 minutes each. A fluorinated solution (0.5% w/w) of ethylene glycol and DI water (10% w/w) was used as an electrolyte. Anodization was done in the two electrode system with platinum as the reference electrode using 40 V DC power supply for 2 hours. Anodized samples were annealed at 450° C. for 2 hours in air.

The cadmium dithioarbamate Cd[(C₂H₅)₂NCS₂]₂ precursor was synthesized by mixing 0.1 M aqueous solution of CdSO₄ into 0.2 M aqueous solution of (C₂H₅)₂NCS₂Na for 3 hours. The resulting solution immediately started precipitating. The white precipitate was then washed thoroughly with DI water and dried in oven for 6 hours at 50° C.

At first 30 mL of oleylamine was heated at temperature 160° C., and then T_NT was dipped in the oleylamine solution. After 5 minutes, the cadmium dithioarbamate precursor (of various concentration range, 0.1 mM, 0.5 mM, 1 mM, 2 mM and 3 mM) was added into the solution and kept at 160° C. for 40 minutes. To remove the organic ligand, the sample was dipped into ethanol and dichloromethane separately for 8 hours. To get better crystallinity the sample was annealed at 350° C. for 3 hours in nitrogen atmosphere.

The UV-visible absorbance studies were performed using a Shimadzu UV-2501PC spectrophotometer in the range of 300 nm-900 nm, in absorbance mode. Imaging of the samples was carried out using a Hitachi FESEM scanning electron microscopy (SEM) machine equipped with an oxford EDS analyzer. The cross-sectional morphology of the electrodes was observed by scratching the samples with a sharp object. A JEOL® 2100F high resolution transmission electron microscope (HR-TEM) was used to examine the size of CdS deposits on T_NT surface. A Philips XRG 3100 X-ray diffractometer, operated at 35 KV was used to obtain the X-ray diffraction pattern and identify the phase of the material after each annealing step, in the film form.

The photoelectrochemical studies were carried out in a three-electrode system, using a quartz cell with Pt mesh as a counter electrode and a leak free Ag/AgCl (in 3M KCl) as the reference electrode. 0.1 M Na₂S in water was used as the electrolyte. J/t and J/V characteristics were collected using an Autolab PGSTAT 30 electrochemical analyzer. The working electrode was irradiated with a 500 W Newport Xenon lamp equipped with 0.5 M CuSO₄ solution as a far UV cutoff filter; this also attenuates the light intensity to ˜90 mW cm⁻².

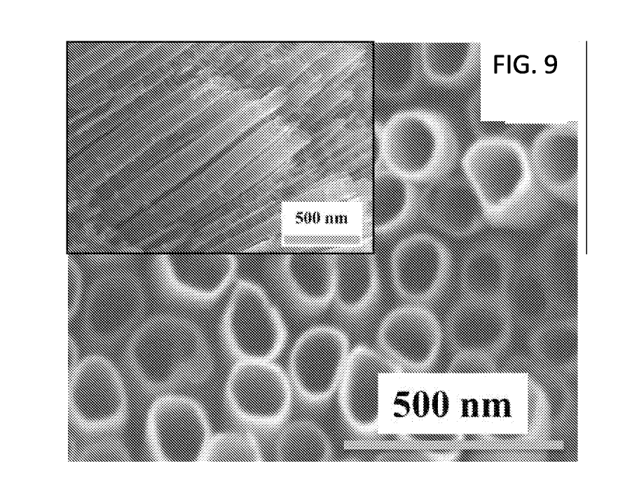

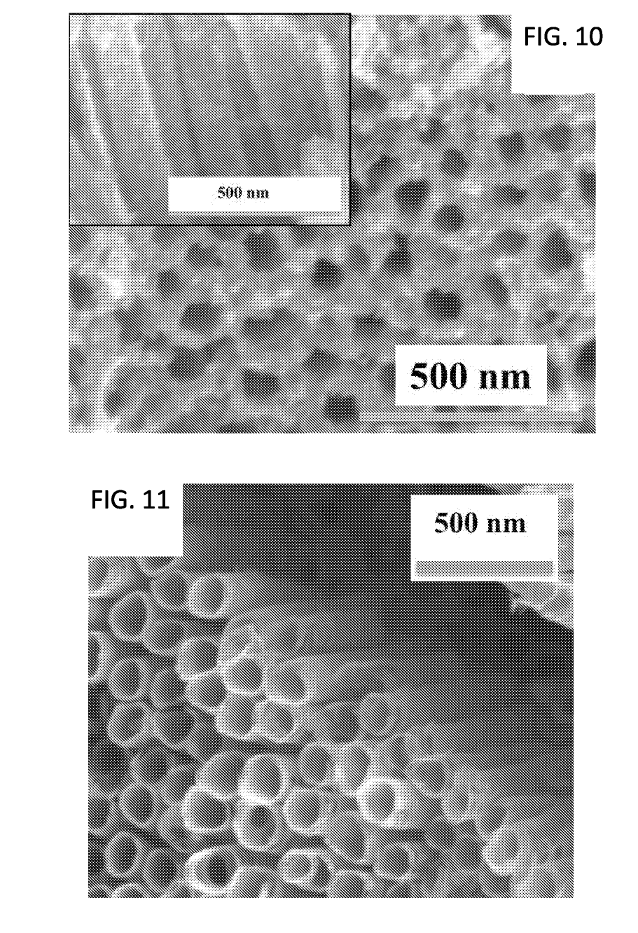

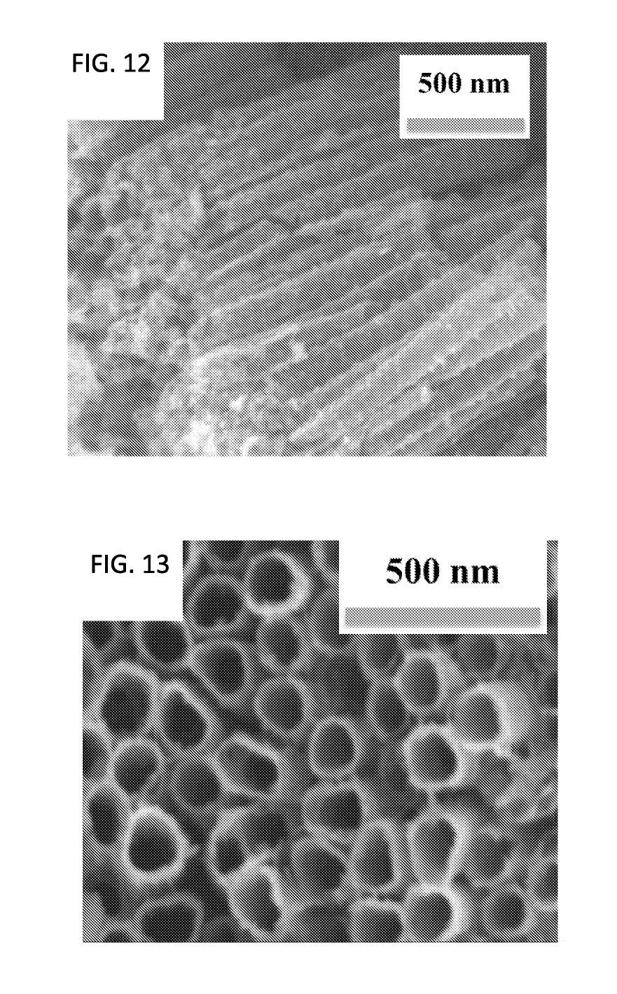

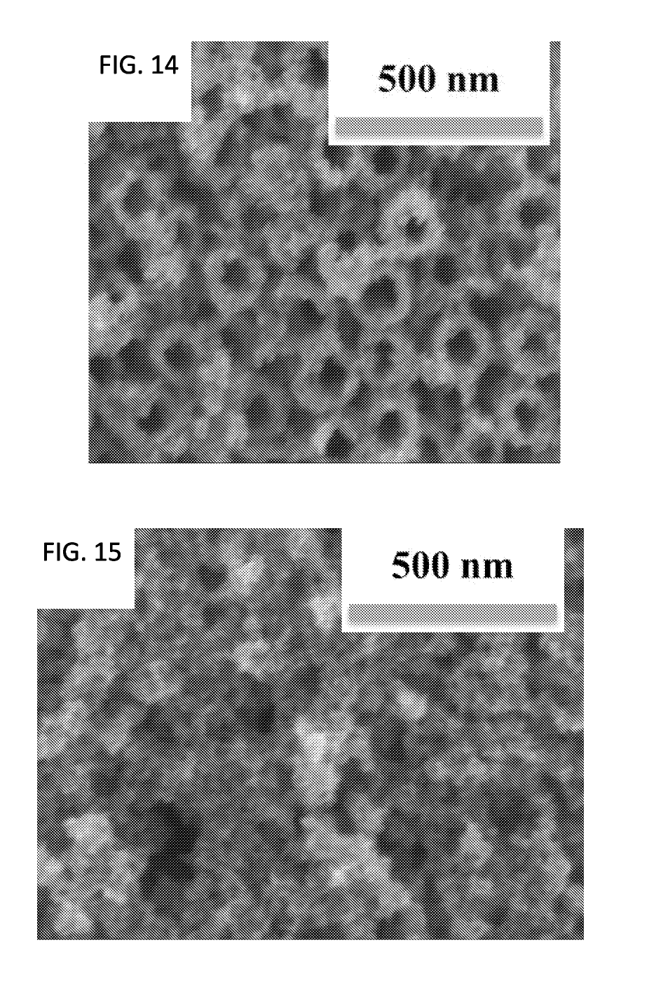

The scanning electron microscopy (SEM) image shown in FIG. 9 indicates cylindrical and well developed titania nanotube (T_NT) arrays, following anodization of Titanium (Ti) foil. The inset of FIG. 9 shows the cross-sectional view of the smooth T_NT surface. The nanotubes are of ˜100 nm in diameter, with distinct interstitial spaces between the adjacent tubes. Post one-pot treatment, uniform coverage (coating thickness of ˜30 nm) was observed all over the nanotubes including the inter-tubular spaces as shown in FIG. 10 (Inset of FIG. 10 shows the cross-sectional view of the T_NT surface with CdS deposits). Additional cross-sectional SEM images of the bare nanotubes (FIG. 11) and with the deposits (FIG. 12) shows that the deposits are present along the mouth and the walls of the nanotubes while the nanotube mouth mostly remains open. This form of deposition is most desirable since, clogging of the T_NT mouth may affect photoactivity due to limited electrolyte transport. It is noteworthy that the approaches that use pre-formed nanoparticles with nanotubes, risk significant clogging of pore mouth—an issue that the disclosed methods are able to avoid. We attribute this observation to the fact that nanocrystals are formed on the surface after diffusion of the precursor to the sites. The T_NT with varying amount of deposits prepared over other concentration ranges are shown in FIGS. 13-15.

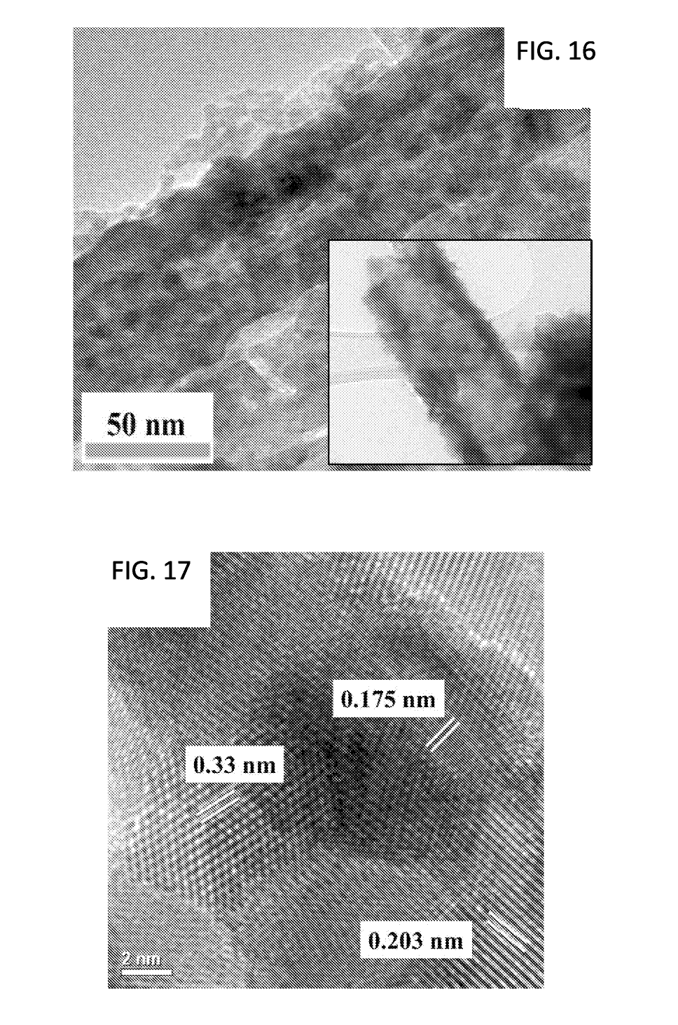

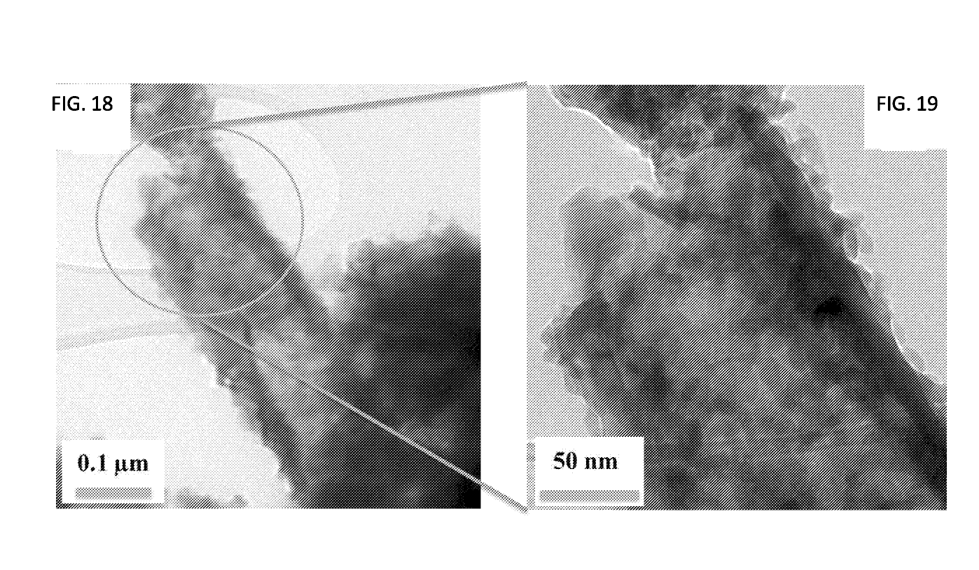

High resolution transmission electron microscopy (HR-TEM) imaging was performed on the composite to determine the surface and composition of the materials. FIG. 16 shows the cross-section of a representative ‘CdS’ coated nanotube. FIG. 17 shows the HR-TEM image of the deposits with additional ‘d-spacing’ values. The deposits are of ˜6 nm in diameter. A corresponding FFT image is shown in FIG. 4. Further TEM images of the deposits various magnifications are shown in FIGS. 18 and 19. The image confirms the observations made in the SEM in that the deposits formed are dense, continuous, and evident along the mouth and length of the walls. Further they demonstrate crystallinity as evident from fringe pattern in the HRTEM as well as the high resolution fast Fourier transformation (FFT) in the insert. These fringes can be indexed to 002 plane and can be identified with the identification of the deposits as CdS nanocrystal. These images indicate the polycrystallanity of the CdS and the identification of the 002 plane indicates the deposits as hexagonal CdS.

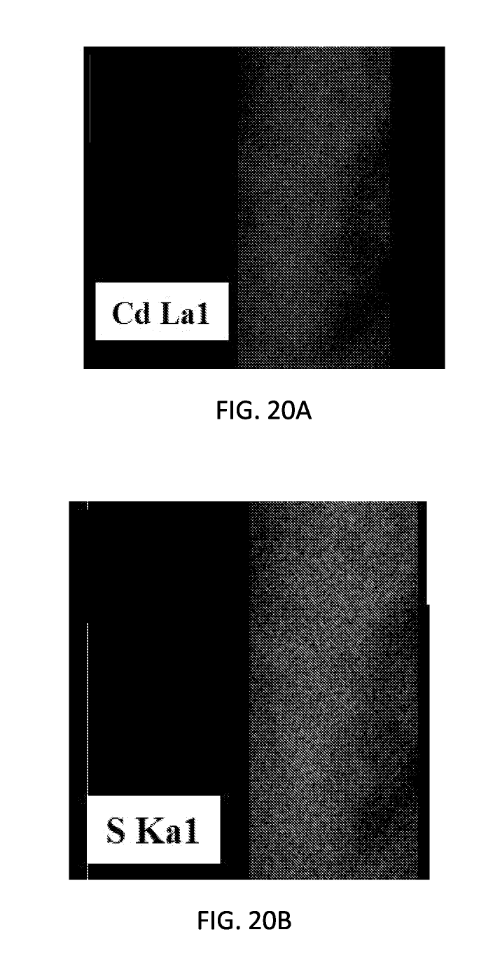

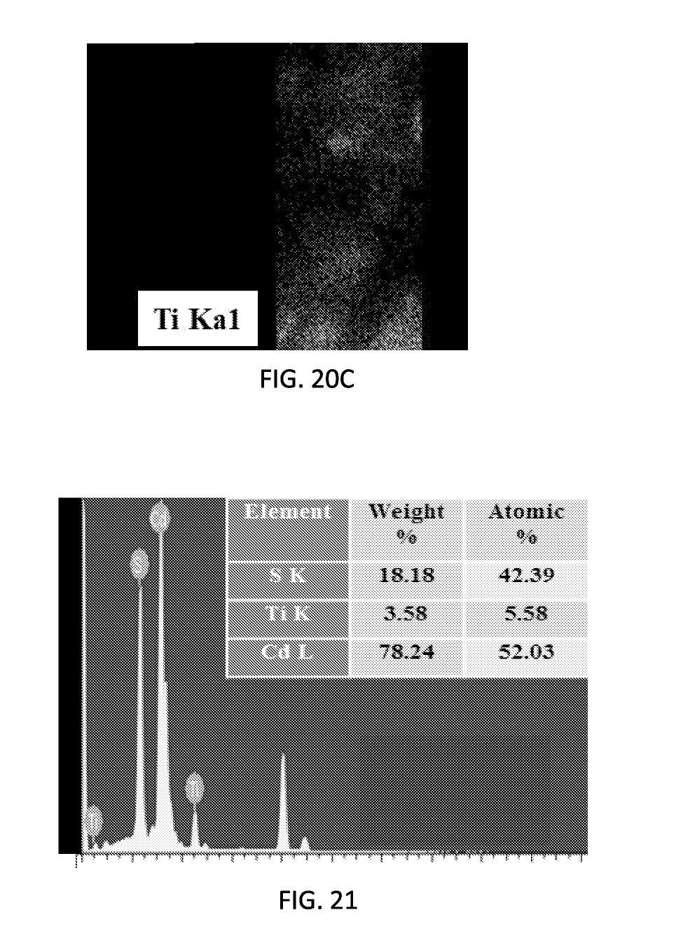

Color resolution analysis of the elements can provide insights into the distribution of the Cd and S across the nanotubes. The decoupled color mapping of the buildings block units in the ‘HOM’, e.g., elemental cadmium (Cd), sulfur (S) and titanium (Ti), are shown in FIGS. 20A-20C. These images indicate that the one-pot method leads to homogeneous distribution of CdS along the cross-sectional length of nanotubes. Further, the energy dispersive X-ray spectroscopy (EDAX) analysis shown in FIG. 21 indicates an average Cd:S ratio of ˜1:1 at the T_NT surface. This form of uniform and robust distribution is a prerequisite to an excellent electronic contact between the two semiconductors and will determine the photoactivity of the composite HOM.

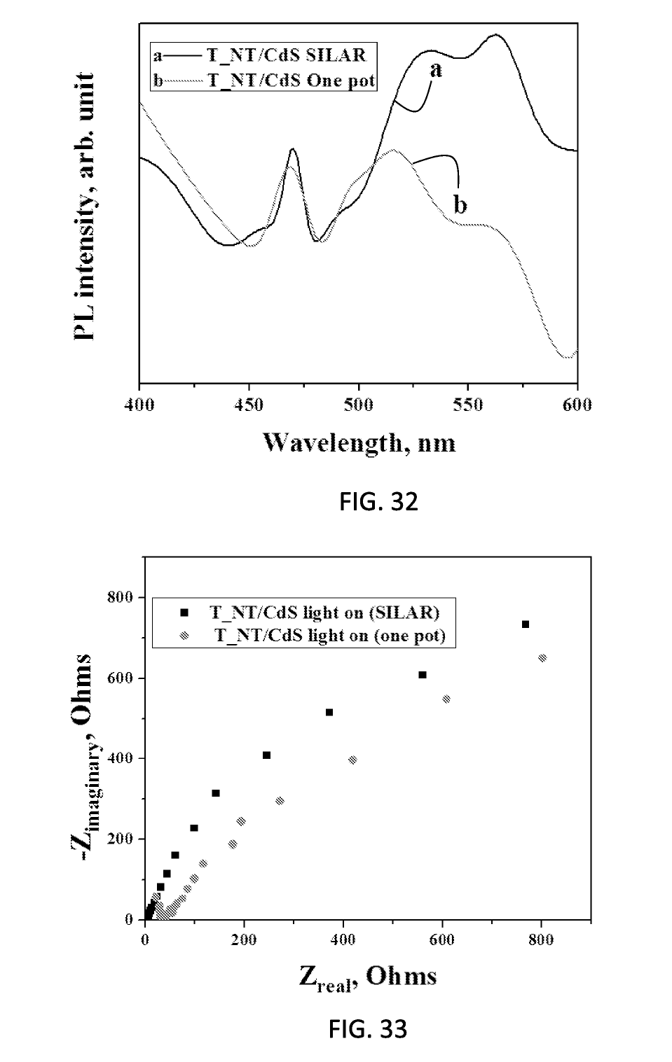

The resistance between CdS/T_NT interfaces was analyzed using photoluminance (PL) spectroscopy with an excitation wavelength of 340 nm. Exemplary results are illustrated in FIG. 32. Two peaks around 520 and 560 result from radiative recombination of the electron-hole pairs between the interface of the CdS and T_NT. From the information provided by FIG. 32, it can be seen that the materials made using the chalcogenide-based method embodiments disclosed herein exhibit weaker radiative recombination of electron hole pairs as compared to materials made using conventional SILAR methods.

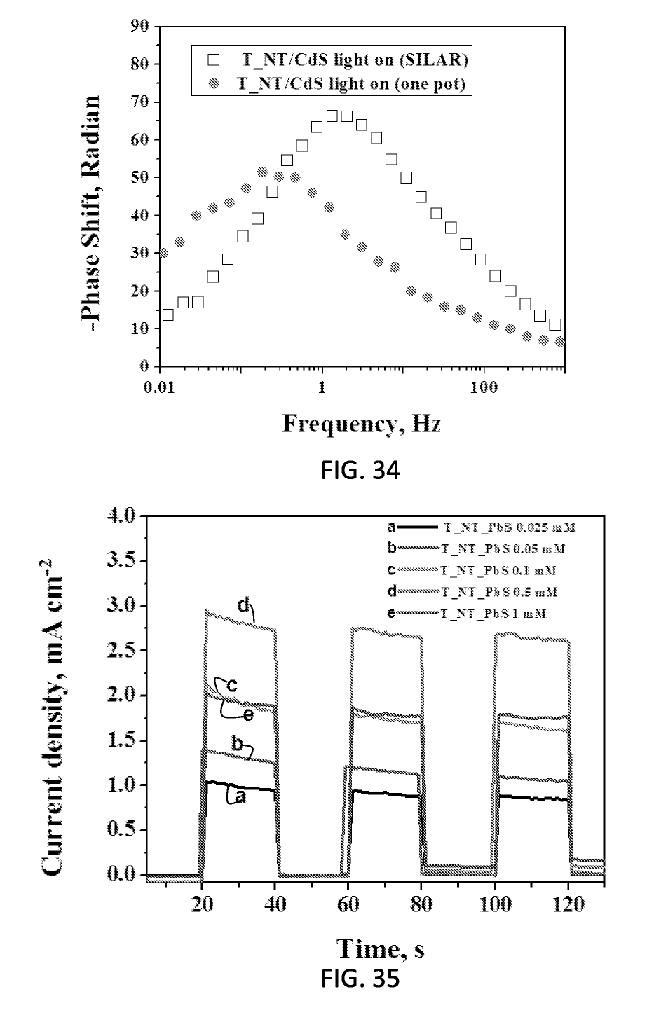

The complex impedance plane or Nyquist plot (FIG. 33) suggests that the charge transfer resistance is higher for materials made using conventional SILAR methods as compared to the materials made using the chalcogenide-based method embodiments describe herein. FIG. 34 compares the results of the Bode impedance plot for the SILAR and exemplary chalcogenide-based methods described herein. The average electron life time of some materials made using the chalcogenide-based method embodiments disclosed herein can be 516 ms whereas materials obtained from the SILAR method have average electron life time of 96 ms. Thus, PL, Nyquist, and Bode analyses indicate that the chalcogenide-based method embodiments disclosed herein enable establishing a strong contact between T_NTs and the chalcogenide material, such as CdS, thus lowering the recombination of the photo-induced electron-hole pairs in the HOM.

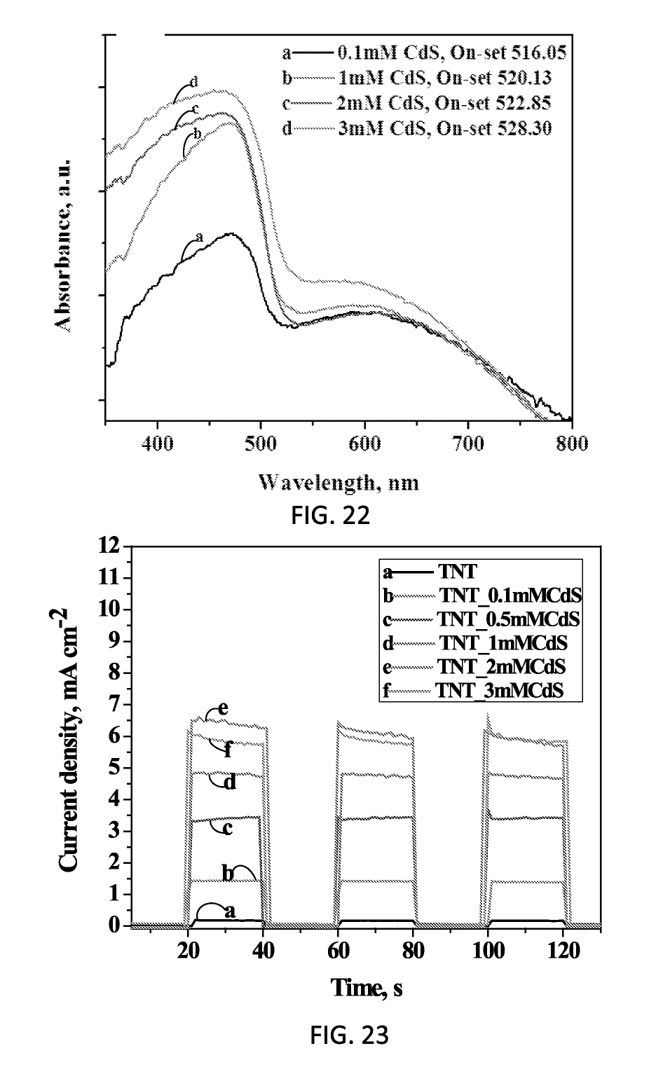

The surface and optical properties of the HOM architecture were also analyzed using X-Ray diffraction (XRD) and UV-visible spectroscopy. The XRD pattern of the nanotube and nanotube with the deposits are shown in FIG. 1. The indexing of these XRD to 21-1272 and 41-1049 files of JCPDS confirm that the nanotubes comprise anatase TiO₂ and the deposits are hexagonal CdS. The absorbance spectra of T_NT with various ‘Cd’ precursor concentrations are shown in FIG. 22. The evidence of an onset at ˜515 nm is in accordance with the CdS nanocrystal absorbance. The gradual blue-shift in the absorbance value (516 nm 4528 nm) with increased precursor concentration is indicative of the growth and densification of the CdS coating on the nanotubes. Thus the SEM, HR-TEM, EDAX, color mapping, and absorbance analysis complement one another and confirm that the one pot approach by far the simplest and most effective approach to the deposition and growth of hexagonal type CdS on the TiO₂ nanotubes.

### Example 2

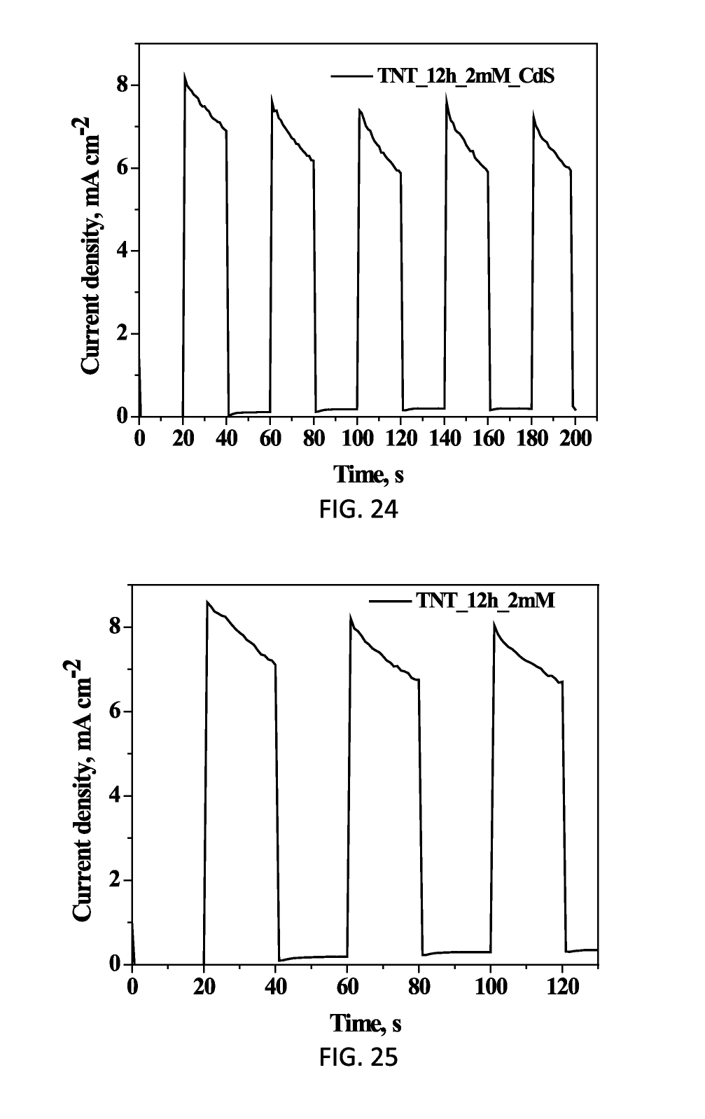

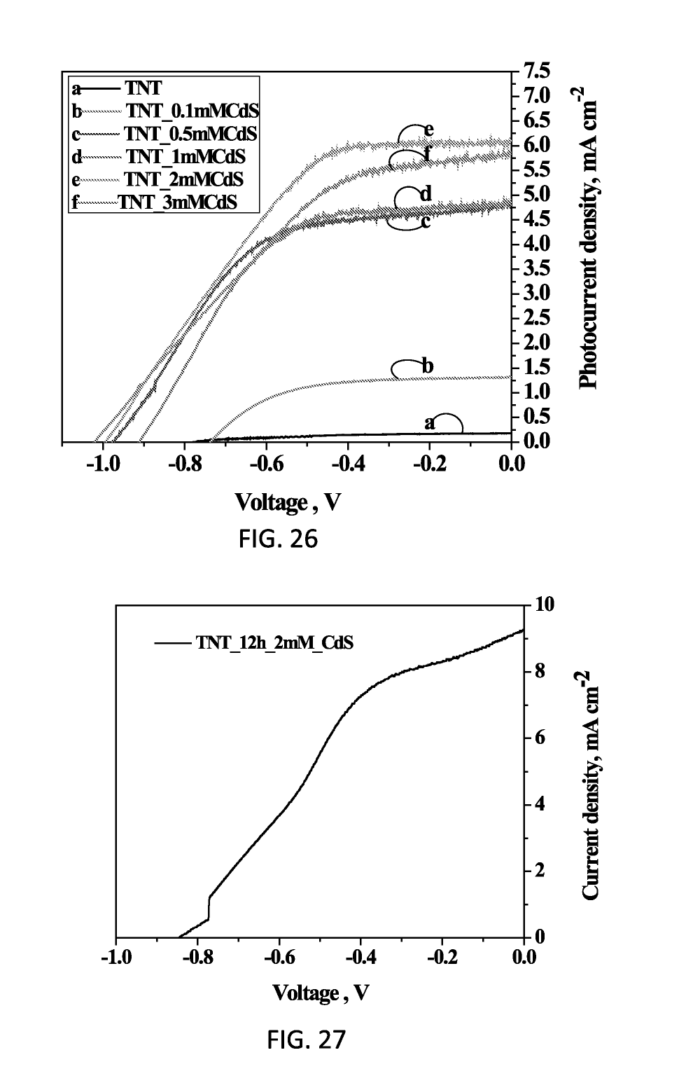

The activity of the HOMs were examined in a two (open circuit) and three electrode (closed circuit) system to evaluate the photoelectrochemical performance. Chronomaperometry (J/t) measurements of the films are shown in the FIG. 22. Additional results are illustrated in FIGS. 24 and 25. The results indicate that the UV-visible illumination leads to an instantaneous response that is reproducible as indicated from the several on-off cycles. The presence of CdS, at even a low precursor concentration of 0.1 mM shows a positive increase compared to the TiO₂ nanotubes. At 6.3 mA cm⁻², a maximum in the photocurrent is observed at a CdS loading with 2 mM precursor concentration [an increase of 29 times over bare TiO₂] beyond which any further increase in the CdS loading leads to reduction in the photocurrent. Current density/Voltage (J/V) analysis indicates the photocurrent response of the HOMs at various applied potentials (FIGS. 26 and 27). All the CdS deposited samples show higher photocurrent compared to the TiO₂ at any applied potential as indicated in FIG. 23. Further, a negative shift in the apparent flat band potential with all the CdS deposits is noted, with the highest noted for the deposited CdS with 2 mM of precursor concentrations. The negative shift is indicative of the charge generation, accumulation, and transport upon photo illumination in the HOM.

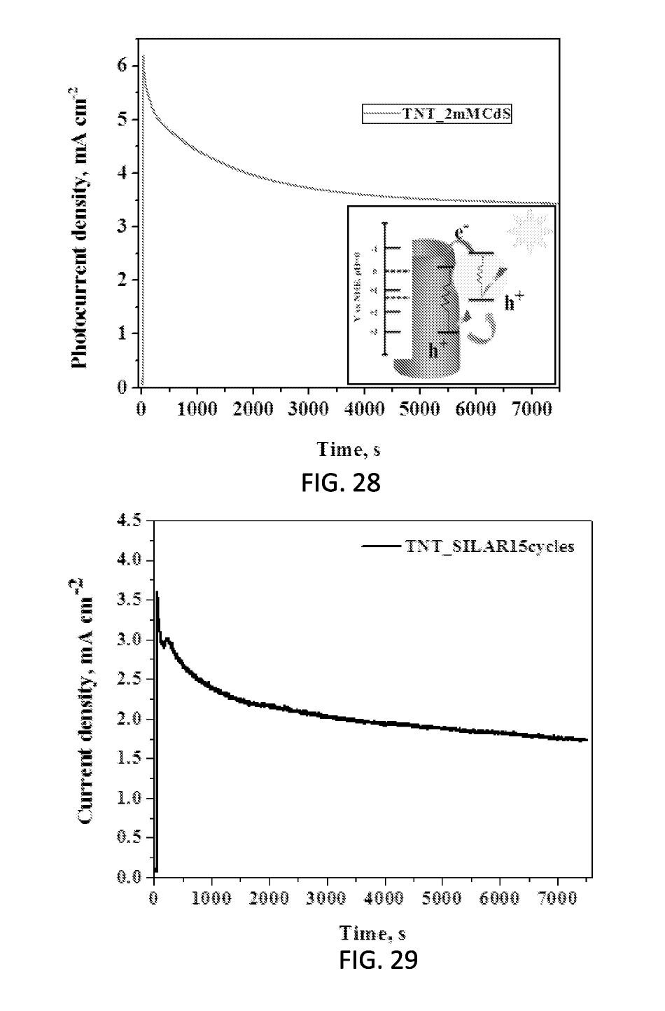

It is known that CdS is prone to corrosion and hence its stability is an important characteristic to maintain for any performance evaluation. Chronoamperometry measurements were therefore performed to evaluate the HOM stability. Since these types of electrodes are used as solar cell anode, a 2-electrode testing was performed over duration of ˜2 hours (FIG. 28). The photocurrent was noted to reduce under continuous illumination [AM 1.5] by only 4.3% after 1 hour. The performance of this electrode was compared with the approaches reported in the art. A SILAR approach was used as the standard since this approach has been reported extensively and considered one of the low cost, reliable, and easily scalable approach to CdS deposit preparation on oxides. FIG. 29 shows the chronoamperometry of an “optically matched” CdS deposit on TiO₂. The decrease is 11%, with a further decrease than the one noted with the HOM presented here. The scheme in the inset of the FIG. 28 shows the mechanism of charge generation and separation in the HOM.

It can be observed from the chronomaperometry (J/t) analysis (FIG. 25), the instantaneous photocurrent value of ˜8.2 mA cm⁻² was achieved by one-pot deposition of CdS over T_NT foil, anodized for 12 hours. The current density/voltage (J/V) analysis of the sample shows a value of 9.3 mA/cm² as indicated in FIG. 27. This is the highest ever reported using a T_NT/QD photoanode.

The lead dithioarbamate Pb[(C₂H₅)₂NCS₂]₂ precursor was synthesized with the same method as cadmium dithioarbamate, except PbSO₄ was used instead of CdSO₄.

At first, 30 mL of oleylamine was heated at 180° C., and then T_NT (preparation described above) was dipped in the oleylamine solution. After 5 minutes, the lead dithioarbamate precursor (of various concentration range, 0.1 mM, 0.5 mM, 1 mM, 2 mM and 3 mM) was added into the solution and kept at 180° C. for 40 minutes. To remove the organic ligand, the sample was dipped into ethanol and dichloromethane separately for 8 hours. To get better crystallinity the sample was annealed at 350° C. for 3 hours in nitrogen atmosphere.

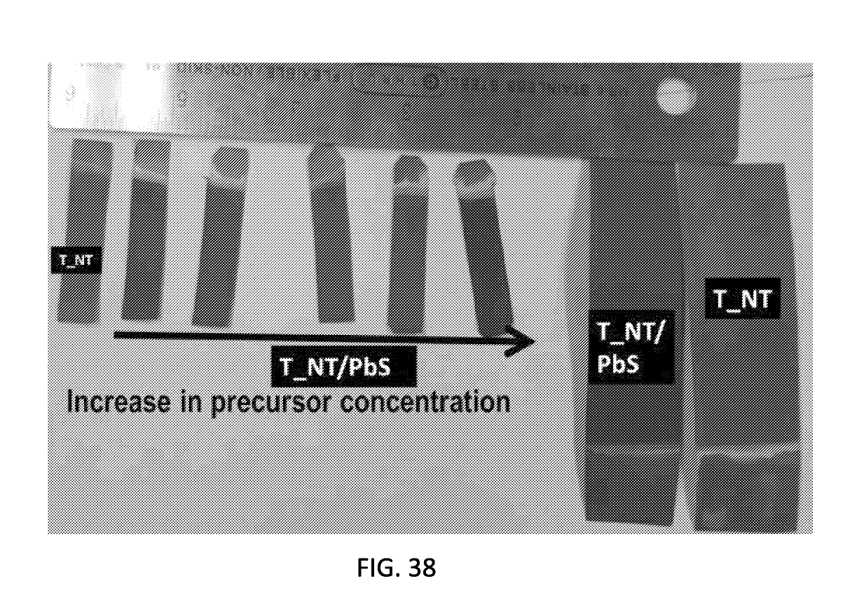

The UV-visible absorbance studies were performed using a Shimadzu UV-2501PC spectrophotometer in the range of 300 nm-900 nm, in absorbance mode. The absorbance spectra of T_NT with various TbS' precursor concentrations are shown in FIG. 37. The figure shows that the deposition of PbS has increased the absorbance in the visible range. An image showing various substrates coupled to the PbS chalcogenide material made with varying precursor concentrations are shown in FIG. 38.

The photoelectrochemical studies were carried out in a three-electrode system, using a quartz cell with Pt mesh as a counter electrode and a leak free Ag/AgCl (in 3M KCl) as the reference electrode. 0.1 M Na₂S in water was used as the electrolyte. J/t and J/V characteristics were collected using an Autolab PGSTAT 30 electrochemical analyzer. The working electrode was irradiated with a 500 W Newport Xenon lamp equipped with 0.5 M CuSO₄ solution as a far UV cutoff filter; this also attenuates the light intensity to ˜90 mW cm⁻².

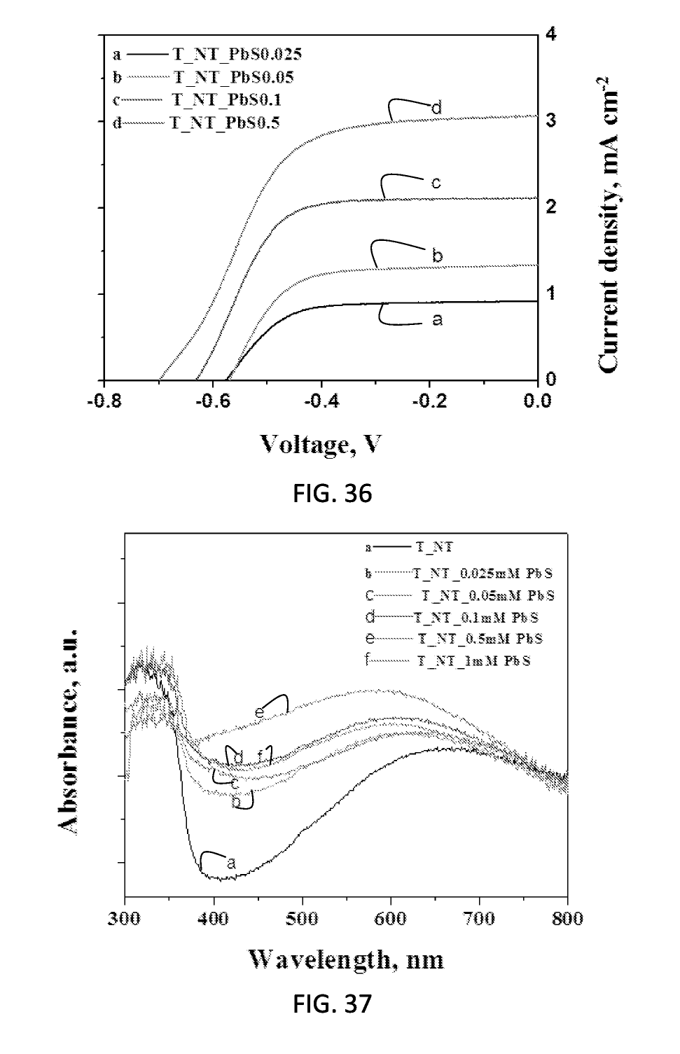

Chronomaperometry (J/t) measurements of the T_NT/PbS films are shown in the FIG. 35. The results indicate that the UV-visible illumination leads to an instantaneous response that is reproducible as indicated from the several on-off cycles. The presence of PbS, at even a low precursor concentration of 0.025 mM shows a positive increase compared to the TiO₂ nanotubes. A maximum photocurrent of ˜3 mA cm⁻² is observed at the loading with 0.5 mM precursor concentration and beyond which any further increase in the PbS precursor loading leads to reduction in the photocurrent. Current density/Voltage (J/V) analysis indicates the photocurrent response of the HOMs at various applied potentials is presented in FIG. 36.

### Overview of Several Embodiments

Disclosed herein are embodiments of a chalcogenide material having a formula MXₙ wherein M is selected from Cd, Cu, Pb, or Zn; X is a chalcogen selected from S, Se, Te, or combinations thereof; and n is 1 or 2; wherein the chalcogenide material exhibits high crystallinity and is chalcogen-deficient.

In any or all of the above embodiments, M is Cd or Pb, X is S, and n is 1.

In any or all of the above embodiments, the chalcogenide material is chalcogen-deficient such that it comprises from greater than zero atomic % of the chalcogen to less than 1 atomic % of the chalcogen.

In any or all of the above embodiments, the chalcogenide material is chalcogen-deficient such that it comprises from 0.1 atomic % of the chalcogen to less than 0.95 atomic % of the chalcogen.

In any or all of the above embodiments, the high crystallinity of the chalcogenide material comprises a high intensity ratio ranging from 2 to 5.

In any or all of the above embodiments, the high crystallinity of the chalcogenide material comprises a high intensity ratio of 3 to 4.

In any or all of the above embodiments, the chalcogenide material is CdS or PbS, and wherein the CdS or PbS exhibits high crystallinity comprising an intensity ratio of 3 to 4 and comprises greater than zero atomic % sulfide to less than 1 atomic % sulfide.

In any or all of the above embodiments, the chalcogenide material is CdS and the CdS exhibits high crystallinity of about 3.90 to about 4.0 and comprises 0.81 to 0.85 atomic % sulfide.

In any or all of the above embodiments, the chalcogenide material produces a photocurrent ranging from 1.5 mA cm⁻² to 9 mA cm⁻².

In some embodiments, a composition for producing a chalcogenide material or a chalcogenide-based material is described, comprising a chalcogenide precursor having a formula ML₁L₂ wherein M is selected from Cd, Cu, Pb, or Zn and each of L₁ and L₂ independently is selected from a ligand comprising at least one chalcogen; wherein the chalcogenide material or chalcogenide-based material exhibits high crystallinity and is chalcogen-deficient.

In any or all of the above embodiments, the composition further comprises a solvent.

In any or all of the above embodiments, the solvent is oleylamine.

In any or all of the above embodiments, M is Cd or Pb.

In any or all of the above embodiments, each of L₁ and L₂ independently are selected from a dithiocarbamate, a dithiol, or a xanthate.

In any or all of the above embodiments, the chalcogenide material or the chalcogenide-based material produced by the composition is chalcogen-deficient such that it comprises from greater than zero atomic % of the chalcogen to less than 1 atomic % of the chalcogen.

In any or all of the above embodiments, the chalcogenide material or the chalcogenide-based material produced by the composition is chalcogen-deficient such that it comprises from 0.1 atomic % of the chalcogen to less than 0.95 atomic % of the chalcogen.

In any or all of the above embodiments, the high crystallinity of the chalcogenide material or chalcogenide-based material comprises a high intensity ratio ranging from 2 to 5.

In any or all of the above embodiments, the high crystallinity of the chalcogenide material or chalcogenide-based material comprises a high intensity ratio of 3 to 4.

In some embodiments, a combination is disclosed, comprising a chalcogenide material having a formula MXₙ wherein M is selected from Cd, Cu, Pb, or Zn; X is a chalcogen selected from S, Se, Te, or combinations thereof; and n is 1 or 2; wherein the chalcogenide material exhibits high crystallinity and is chalcogen-deficient; and a substrate.

In any or all of the above embodiments, M is Cd or Pb, X is S, and n is 1.

In any or all of the above embodiments, the chalcogenide material is chalcogen-deficient such that it comprises from greater than zero atomic % of the chalcogen to less than 1 atomic % of the chalcogen.

In any or all of the above embodiments, the chalcogenide material is chalcogen-deficient such that it comprises from 0.1 atomic % of the chalcogen to less than 0.95 atomic % of the chalcogen.

In any or all of the above embodiments, the high crystallinity of the chalcogenide material comprises a high intensity ratio ranging from 2 to 5.

In any or all of the above embodiments, the high crystallinity of the chalcogenide material comprises a high intensity ratio of 3 to 4.

In any or all of the above embodiments, the chalcogenide material is CdS or PbS, and wherein the CdS or PbS exhibits high crystallinity comprising an intensity ratio of 3 to 4 and comprises greater than zero atomic % sulfide to less than 1 atomic % sulfide.

In any or all of the above embodiments, the chalcogenide material is CdS and the CdS exhibits high crystallinity of about 3.90 to about 4.0 and comprises 0.81 to 0.85 atomic % sulfide.

In any or all of the above embodiments, the chalcogenide material produces a photocurrent ranging from 1.5 mA cm⁻² to 9 mA cm⁻².

In some embodiments, a method for making a chalcogenide-coated substrate is described, which comprises exposing a substrate to a composition comprising a chalcogenide precursor having a formula ML₁L₂ wherein M is selected from Cd, Cu, Pb, or Zn and each of L₁ and L₂ independently is selected from a ligand comprising at least one chalcogen; wherein the chalcogenide-coated substrate produces a photocurrent ranging from 1.5 mA cm⁻² to 9 mA cm⁻².

In any or all of the above embodiments, exposing the substrate to the composition comprises dipping the substrate into the composition at a temperature and for a time period sufficient to deposit a chalcogenide material onto the substrate.

In any or all of the above embodiments, the temperature ranges from 140° C. to 240° C.

In any or all of the above embodiments, the time period ranges from 45 minutes to 60 minutes.

In any or all of the above embodiments, the chalcogenide-coated substrate is substantially coated with the chalcogenide material.

In any or all of the above embodiments, the method consists of exposing the substrate to the chalcogenide precursor at a temperature and for a time sufficient to deposit a chalcogenide material onto the substrate.

In some embodiments, a method for making a chalcogenide-coated substrate is described wherein the method comprises comprising exposing a titanium oxide substrate to a composition comprising a chalcogenide precursor comprising Cd or Pb and a ligand selected from a dithiocarbamate, a dithiol, or a xanthate; wherein the chalcogenide-coated substrate produces a photocurrent of at least 6 mA cm⁻².

In any or all of the above embodiments, the titanium oxide substrate is a TiO₂ nanotube and the chalcogenide precursor is Cd[(C₂H₅)₂NCS₂]₂ or Pb[(C₂H₅)₂NCS₂]₂.

In view of the many possible embodiments to which the principles of the present disclosure may be applied, it should be recognized that the illustrated embodiments are only preferred examples of the disclosure and should not be taken as limiting the scope of the disclosure. Rather, the scope of the disclosure is defined by the following claims. We therefore claim all that comes within the scope and spirit of these claims.

1. A chalcogenide material having a formula MXₙ wherein M is selected from Cd, Cu, Pb, or Zn; X is a chalcogen selected from S, Se, Te, or combinations thereof; and n is 1 or 2; wherein the chalcogenide material exhibits high crystallinity and is chalcogen-deficient.

2. The chalcogenide material of claim 1, wherein M is Cd or Pb, X is S, and n is 1.

3. The chalcogenide material of claim 1, wherein the chalcogenide material is chalcogen-deficient such that it comprises from greater than zero atomic % of the chalcogen to less than 1 atomic % of the chalcogen.

4. The chalcogenide material of claim 1, wherein the chalcogenide material is chalcogen-deficient such that it comprises from 0.1 atomic % of the chalcogen to less than 0.95 atomic % of the chalcogen.

5. The chalcogenide material of claim 1, wherein the high crystallinity of the chalcogenide material comprises a high intensity ratio ranging from 2 to 5.

6. (canceled)

7. The chalcogenide material of claim 1, wherein the chalcogenide material is CdS or PbS, and wherein the CdS or PbS exhibits high crystallinity comprising an intensity ratio of 3 to 4 and comprises greater than zero atomic % sulfide to less than 1 atomic % sulfide.

8. The chalcogenide material of claim 1, wherein the chalcogenide material is CdS and the CdS exhibits high crystallinity of about 3.90 to about 4.0 and comprises 0.81 to 0.85 atomic % sulfide.

9. (canceled)

10. A composition for producing a chalcogenide material or a chalcogenide-based material, comprising a chalcogenide precursor having a formula ML₁L₂ wherein M is selected from Cd, Cu, Pb, or Zn and each of L₁ and L₂ independently is selected from a ligand comprising at least one chalcogen; wherein the chalcogenide material or chalcogenide-based material exhibits high crystallinity and is chalcogen-deficient.

11. The composition of claim 10, wherein the composition further comprises a solvent.

12. The composition of claim 11, wherein the solvent is oleylamine.

13. The composition of claim 10, wherein M is Cd or Pb and each of L₁ and L₂ independently are selected from a dithiocarbamate, a dithiol, or a xanthate.

14. (canceled)

15. The composition of claim 10, wherein the chalcogenide material or the chalcogenide-based material produced by the composition is chalcogen-deficient such that it comprises from greater than zero atomic % of the chalcogen to less than 1 atomic % of the chalcogen and/or wherein the high crystallinity of the chalcogenide material or chalcogenide-based material comprises a high intensity ratio ranging from 2 to 5.

16-18. (canceled)

19. A combination, comprising:
the chalcogenide material of claim 1; and
a substrate.

20. The combination of claim 19, wherein M is Cd or Pb, X is S, and n is 1.

21. The combination of claim 19, wherein the chalcogenide material is chalcogen-deficient such that it comprises from greater than zero atomic % of the chalcogen to less than 1 atomic % of the chalcogen and/or wherein the high crystallinity of the chalcogenide material or chalcogenide-based material comprises a high intensity ratio ranging from 2 to 5.

22-24. (canceled)

25. The combination of claim 19, wherein the chalcogenide material is CdS or PbS, and wherein the CdS or PbS exhibits high crystallinity comprising an intensity ratio of 3 to 4 and comprises greater than zero atomic % sulfide to less than 1 atomic % sulfide.

26. The combination of claim 19, wherein the chalcogenide material is CdS and the CdS exhibits high crystallinity of about 3.90 to about 4.0 and comprises 0.81 to 0.85 atomic % sulfide.

27. The combination of claim 19, wherein the chalcogenide material produces a photocurrent ranging from 1.5 mA cm⁻² to 9 mA cm⁻².

28. A method for making a chalcogenide-coated substrate, comprising exposing a substrate to a composition comprising a chalcogenide precursor having a formula ML₁L₂ wherein M is selected from Cd, Cu, Pb, or Zn and each of L₁ and L₂ independently is selected from a ligand comprising at least one chalcogen; wherein the chalcogenide-coated substrate produces a photocurrent ranging from 1.5 mA cm⁻² to 9 mA cm⁻².

29. The method of claim 28, wherein exposing the substrate to the composition comprises dipping the substrate into the composition at a temperature ranging from 140° C. to 240° C. and for a time period ranging from 45 minutes to 60 minutes.

30-31. (canceled)

32. The method of claim 28, wherein the chalcogenide-coated substrate is substantially coated with the chalcogenide material.

33. The method of claim 28, wherein the method consists of exposing the substrate to the chalcogenide precursor at a temperature and for a time sufficient to deposit a chalcogenide material onto the substrate.

34. The method of claim 28, wherein the substrate is a titanium oxide substrate and the chalcogenide precursor comprises Cd or Pb and a ligand selected from a dithiocarbamate, a dithiol, or a xanthate; and wherein the chalcogenide-coated substrate produces a photocurrent of at least 6 mA cm⁻².

35. The method of claim 34, wherein the titanium oxide substrate is a TiO₂ nanotube and the chalcogenide precursor is Cd[(C₂H₅)₂NCS₂]₂ or Pb[(C₂H₅)₂NCS₂]₂.
